(19) United States
(12) Patent Application Publication
(10) Pub. No.: US 2015/0006830 A1
(43) Pub. Date: Jan. 1, 2015

(54) STORAGE SYSTEM AND METHOD FOR OPERATING THE SAME

(71) Applicant: Samsung Electronics Co., Ltd., Suwon-si (KR)

(72) Inventors: Hyun-jung SHIN, Yongin-si (KR); Ju-Pyung LEE, Suwon-si (KR); Jung-Min SEO, Seongnam-si (KR)

(73) Assignee: Samsung Electronics Co., Ltd., Suwon-si (KR)

(21) Appl. No.: 14/315,590

(22) Filed: Jun. 26, 2014

(30) Foreign Application Priority Data
Jun. 26, 2013 (KR) 10-2013-0073893

(51) Int. Cl. G06F 3/06

(52) U.S. Cl. CPC G06F 3/0659; G06F 3/0604; G06F 3/0658; G06F 3/0673; G06F 2003/0697
USPC 711/154

(57) ABSTRACT

Provided are a storage system and method for operating the same. A controller of a storage system includes: a storage device selection unit configured to select a storage device to process a command among a plurality of storage devices; a command process request unit configured to request the selected storage device to process the command within a timeout, wherein the storage device selection unit configured to re-select a storage device among the plurality of storage devices to process the command according to a result of determining whether the command can be processed by the selected storage device within the timeout.

### CROSS-REFERENCE TO RELATED APPLICATIONS

This application is based on and claims priority from Korean Patent Application No. 10-2013-0073893, filed on Jun. 26, 2013 in the Korean Intellectual Property Office, the disclosure of which is incorporated herein in its entirety by reference.

### BACKGROUND

1. Field

Apparatuses and methods consistent with exemplary embodiments relate to a storage system and operating the same.

2. Description of the Prior Art

In a storage array or a distributed storage system, if a host makes a read or write request to a storage device, the host waits until a corresponding process with respect to the request is completed in the storage device and is simply notified of the result of the process, such as success or failure, with respect to the request. Even in the case where the result of the process is success, if the process with respect to the request is delayed long in the storage device, the host is unable to be aware of such delay, and thus is unlimitedly in a waiting state until a result value is sent from the storage device.

Most storage arrays or distributed storage systems store a replica or a parity to safely keep data, and if a delay occurs in a specific storage device, the host may read corresponding data from another storage device. However, in the related art, the host should wait until the process with respect to the request is completed in the corresponding storage device.

### SUMMARY

One or more exemplary embodiments provide a controller of a storage system controlling a plurality of storage devices and methods of controlling the same.

According to an aspect of an exemplary embodiment, there is provided a controller of a storage system including: a storage device selection unit configured to select a storage device to process a command among a plurality of storage devices; a command process request unit configured to request the selected storage device to process the command within a timeout, wherein the storage device selection unit configured to re-select a storage device among the plurality of storage devices to process the command according to a result of determining whether the command can be processed by the selected storage device within the timeout.

According to an aspect of another exemplary embodiment, there is provided a storage device of a storage system including: an expected processing time calculation unit configured to calculate an expected processing time for processing a command in accordance with a command process request from a storage system controller; and a command process possibility determination unit configured to determine whether the command can be processed within a timeout based on the calculated expected processing time.

According to an aspect of still another exemplary embodiment, there is provided a storage system including: two or more of the above storage device; and a storage system controller configured to select a storage device to process the command among the two or more of the storage device, and request the selected storage device to process the command within the timeout, wherein the storage system controller is further configured to re-select a storage device among the two or more of the storage device to process the command according to a result of determining whether the command can be processed by the selected storage device within the timeout.

### BRIEF DESCRIPTION OF THE DRAWINGS

The above and other aspects of the exemplary embodiments will be more apparent from the following detailed description taken in conjunction with the accompanying drawings, in which:

FIG. 1 is a diagram illustrating a schematic configuration of a storage system according to an exemplary embodiment;

FIG. 2 is a diagram illustrating a detailed configuration a storage system controller in FIG. 1, according to an exemplary embodiment;

FIG. 3 is a diagram illustrating a detailed configuration of a storage device in FIG. 1, according to an exemplary embodiment;

FIG. 4 is a diagram explaining an example of an Application Program Interface (API) between a storage system controller and a storage device, according to an exemplary embodiment;

FIG. 5 is a flowchart illustrating a method for operating a storage system according to an exemplary embodiment;

FIG. 6 is a flowchart illustrating a method for operating a storage system according to another exemplary embodiment; and

FIG. 7 is a flowchart illustrating a method for operating a storage system according to still another exemplary embodiment.

### DETAILED DESCRIPTION OF THE EXEMPLARY EMBODIMENTS

Advantages and features of the present inventive concept and methods of accomplishing the same may be understood more readily by reference to the following detailed description of exemplary embodiments and the accompanying drawings. The present inventive concept may, however, be embodied in many different forms and should not be construed as being limited to the embodiments set forth herein. Rather, these embodiments are provided such that this disclosure will be thorough and complete and will fully convey the concept of the inventive concept to those skilled in the art, and the present inventive concept will only be defined by the appended claims Like reference numerals refer to like elements throughout the specification.

The terminology used herein is for the purpose of describing particular exemplary embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The exemplary embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein

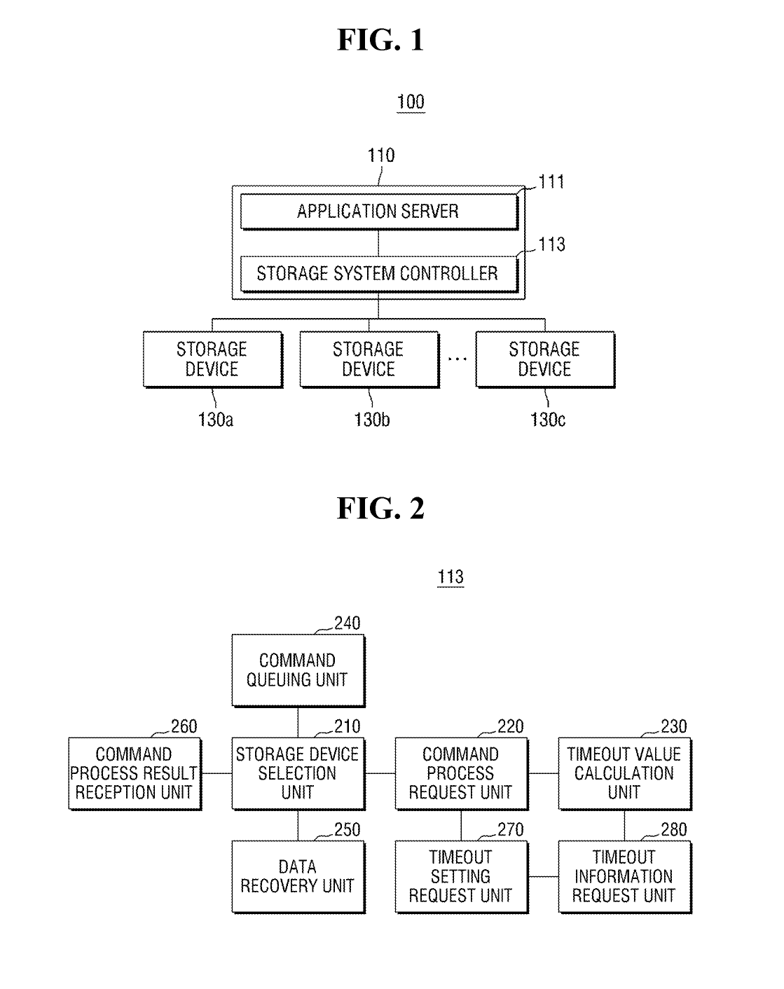

FIG. 1 is a diagram illustrating a schematic configuration of a storage system according to an exemplary embodiment.

Referring to FIG. 1, a storage system 100 according to an exemplary embodiment of the present inventive concept may include a host 110 and storage devices 130a to 130c. The storage system 100 may be implemented by a storage structure that includes a plurality of storage devices 130a to 130c. In this case, the storage structure may have both a storage array in which the plurality of storage devices 130a to 130c are configured as a single node and a distributed storage structure in which the plurality of storage devices 130a to 130c are divided into a plurality of nodes that are connected through a network.

The host 110 may include an application server 111 and a storage system controller 113.

The application server 111 may generate a write command for storing or writing data in the storage devices 130a to 130c and transmit the generated write command to the storage system controller 113. Further, the application server 111 may generate a read command for reading data stored in the storage devices 130a to 130c and transmit the generated read command to the storage system controller 113. In this case, the application server 111 may include a file system and a database.

The storage system controller 113 may distribute the command (read command or write command) that is received from the application server 111 to the respective storage devices 130a to 130c.

The respective storage devices 130a to 130c may read or write data in accordance with the command that is distributed by the storage system controller 113.

According to an exemplary embodiment, the storage devices 130a to 130c may be implemented by a Solid State Drive or Solid State Disk (SSD). However, the storage device is not limited to the SSD, but may be implemented in various types. For example, the storage devices 130a to 130c may be integrated into one semiconductor device, and may be implemented by a personal computer card such as Personal Computer Memory Card International Association (PCMCI), a compact flash card (CF), a smart media card (SM, SMC, or the like), a memory stick, a multimedia card (MMC, RS-MMC, or MMCmicro), an SD card (SD, miniSD, microSD, or SDHC), or a universal flash storage device (UFS).

FIG. 2 is a diagram illustrating a detailed configuration of a storage system controller 113 in FIG. 1, according to an exemplary embodiment.

Referring to FIG. 2, the storage system controller 113 may include a storage device selection unit 210, a command process request unit 220, a timeout value calculation unit 230, a command queuing unit 240, a data recovery unit 250, and a command process result reception unit 260. Hereinafter, for convenience of description, it is assumed that a storage device that is selected as a storage device to process a command is a storage device 130a of FIG. 1.

The storage device selection unit 210 may select the storage device 130 which is to process the command that is received from the application server 111 among the plurality of storage devices 130a to 130c. In this case, as a method for selecting a storage device to process the command, various command distribution algorithms may be used.

The storage device selection unit 210 may select a storage device again, among the plurality of storage devices 130a to 130c, to process the command by receiving a result of determining whether the command can be processed in a timeout (or a predetermined processing time) from the storage device 130a. That is, the storage device selection unit 210 may select another storage device among the plurality of storage devices 130b and 130c or re-select the storage device 130a to process the command according to the result of determining whether the command can be processed in the timeout.

The command process request unit 220 may make a request (hereinafter referred to as a “command process request”) to process the command that is received from the application server 111 in the timeout to the storage device 130a that is selected by the storage device selection unit 210.

According to an exemplary embodiment, the command process request unit 220 may transmit a value of the timeout, i.e., a timeout value, or information about the timeout when the command process request is received. That is, the command process request unit 220 may request to process the command in the timeout by transmitting the timeout value together with the command. In order to transmit the timeout value, following methods may be uses as examples: a method for transmitting the timeout value through or by adding a parameter for the timeout value to an existing read or write Application Program Interface (API), or a method for transmitting the timeout value through or by using an API that is newly defined to transmit the timeout value separately from the existing read or write API.

According to another exemplary embodiment, the timeout may be preset in the storage device 130a. In this case, the command process request unit 220 may request to process the command within the timeout that is preset in the storage device 130a by transmitting the command only. In this case, the storage system controller 113 may further include a timeout setting request unit 270 and a timeout information request unit 280.

The timeout setting request unit 270 may request the storage devices 130a to 130c to set the timeout. For example, the timeout setting request unit 270 may request the storage devices 130a to 130c to set the timeout by application servers, by storage devices, or by commands such as read or write commands. That is, the timeout may differ by application servers, by storage devices or by commands. Specifically, the timeout may be set differently according to characteristics of application servers, storage devices, or commands.

The timeout setting request unit 270 may also modify a preset timeout by requesting the storage devices 130a to 130c, which have the preset timeout, to set a new timeout.

The timeout information request unit 280 may request a storage device, in which the timeout has been preset, to provide information about the preset timeout. Here, the information may include a value of the preset timeout.

The timeout value calculation unit 230 may calculate or modify the timeout value based on Quality of Service (QoS) information about the application server 111 and delay information (e.g., command queuing time information, or delay time information in a bus or network interface) in the storage system controller 113. The timeout value calculated by the timeout value calculation unit 230 may also differ by application servers, by storage devices, by read commands or write commands, or by commands.

According to a first exemplary embodiment, the timeout value may be determined by the application server 111 and may be transferred to the storage system controller 113. According to a second exemplary embodiment, the timeout value may be self-calculated by the storage system controller 113 based on the QoS information of the application server 111.

According to the first exemplary embodiment, the timeout value is transmitted from the application server 111 to the storage device 130a through the storage system controller 113. Accordingly, due to a delay that may occur in the storage system controller 113, the time when the application server 111 transmits the timeout value to the storage system controller 113 may be different from the time when the storage device 130a receives the timeout value. In this case, it is possible for the timeout value calculation unit 230 to modify the timeout value that is designated by the application server 111 in consideration of the delay information (e.g., command queuing time information, or delay time information in a bus or network interface) in the storage system controller 113.

According to the second exemplary embodiment, in the same manner as the first exemplary embodiment, the delay information (e.g., command queuing time information, or delay time information in a bus or network interface) in the storage system controller 113 may be considered when the timeout value is calculated. That is, the timeout value calculation unit 230 may calculate the timeout value in consideration of the detailed information when the timeout value is initially calculated, and may modify the initially calculated timeout value in consideration of the above-described information.

According to a third exemplary embodiment where no information for calculating the processing time is provided from the application server 111, the timeout value calculation unit 230 may statistically calculate an average latency of the whole system or may calculate the timeout value according to various environments and situations, for example, in consideration of performance of the storage device.

The command queuing unit 240 may perform queuing of commands that are received from the application server 111.

If an error code is received from the storage device 130a or there is no response from the storage device 130a within the timeout, the data recovery unit 250 may determine that an error or trouble has occurred in the storage device 130a and recover data through or by performing a data recovery work.

The command process result reception unit 260 may receive a result of processing the command from the storage device 130a.

In accordance with the performance and purpose of the system, the timeout value calculation unit 230, the command queuing unit 240, the data recovery unit 250, and the command process result reception unit 260 may be omitted, and according to circumstances, they may be implemented outside the storage system controller 113.

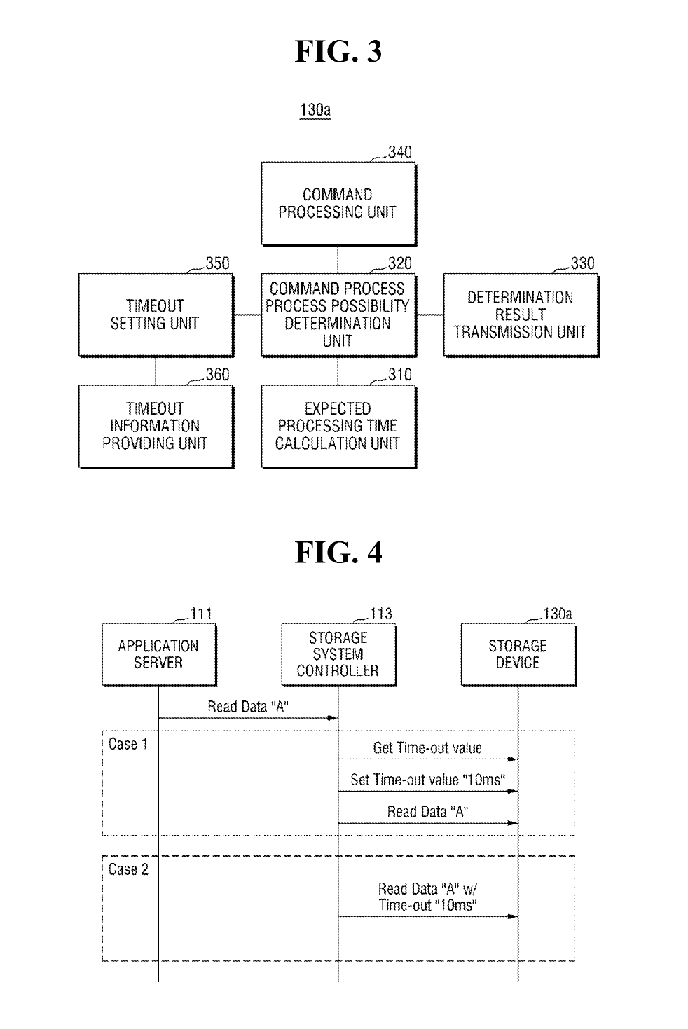

FIG. 3 is a diagram illustrating a detailed configuration of a storage device 130a in FIG. 1, according to an exemplary embodiment.

Storage devices 130b and 130c include the same configuration as the storage device 130a with the same function, and thus the description of the storage device 130a may also be applied to the storage devices 130b and 130c.

Referring to FIG. 3, the storage device 130a may include an expected processing time calculation unit 310, a command process possibility determination unit 320, a determination result transmission unit 330, and a command processing unit 340.

The expected processing time calculation unit 310 may receive a command process request from the storage system controller 113 of the host 110 in FIG. 1, and calculate an expected processing time for processing a command included in the command process request by determining internal circumstances of the storage device 130a in accordance with the command process request of the storage system controller 113. For example, the expected processing time calculation unit 310 may calculate the expected processing time based on the kind and the number of commands queued inside the storage device 130a, predict a processing time for processing another command or operation (e.g., garbage collection in SSD) when the storage device 130a is performing the other command or operation, and calculate the expected processing time for processing the command from the storage system controller 113 based on this prediction of the processing time for processing the other command or operation. Further, if an error has occurred or occurs inside the storage device 130a and recovery thereof is required, the expected processing time calculation unit 310 may predict the recovery time, and calculate the expected processing time based on this prediction of the recovery time.

The command process possibility determination unit 320 may determine whether the storage device 130 can process the received command within a timeout by comparing the expected processing time that is calculated by the expected processing time calculation unit 310 with a timeout value. For example, if the timeout value is equal to or longer than the expected processing time, the command process possibility determination unit 320 may determine that the command can be processed within the timeout, while if the timeout value is shorter than the expected processing time, the command process possibility determination unit 320 may determine that the command is unable to be processed within the timeout.

In this case, the timeout value may be a value that is received together with the command process request.

According to an exemplary embodiment, the timeout value may be a value preset in the storage device 130a. In this case, the storage device 130a may further include a timeout setting unit 350 and a timeout information providing unit 360.

The timeout setting unit 350 may set the timeout in accordance with a timeout setting request from the timeout setting request unit 270 of the storage system controller 113. In this case, the timeout value may be included in the timeout setting request from the timeout setting request unit 270 of the storage system controller 113. For example, the timeout setting unit 350 may set the timeout by application servers, storage devices, by read or write commands, or by commands.

The timeout information providing unit 360 may provide information about a timeout preset by the timeout setting unit 350 to the storage system controller 113 in accordance with a timeout information request from the timeout information request unit 280 of the storage system controller 113. Here, the timeout information may include a value of the preset timeout.

The determination result transmission unit 330 may transmit a result of the determination that is performed by the command process possibility determination unit 320 to the storage system controller 113. According to an exemplary embodiment, if it is determined that the command is unable to be processed within the timeout, the determination result transmission unit 330 may transmit a result value, such as “busy”, that indicates a normal delay or a result value, such as “error” or “fault”, that indicates an error. Further, if it is determined that the command can be processed within the timeout, the determination result transmission unit 330 may transmit a result value, such as “OK” or may transmit no information. In this case, since the command processing unit 340 processes the command and transmits a result of processing, it can act as a substitute for the determination result determination unit 330 that transmits the result of the determination.

If it is determined by the command process possibility determination unit 320 that the command can be processed within the timeout, the command processing unit 340 may process the command and transmit a result of the processing to the storage system controller 113. For example, the command processing unit 340 may read the stored data in accordance with a read command, or may store or write the data in accordance with a write command.

If a preset timeout in the storage device shorter than the processing time that is required by the storage devices 130a to process the command, the storage device 130a is unable to provide a normal service, and thus can determine the minimum value of the timeout value. That is, if a timeout setting request from the timeout setting request unit 270 of the system controller 113 contains a timeout value which is less than or equal to the minimum timeout value determined by the storage device 130a, the storage device 130a may modify and set the timeout value to the minimum timeout value that is determined by the storage devices 130a itself.

Further, in accordance with a user's request, the storage system controller 113 may cancel the timeout process of the storage device 130a by making a timeout setting request in which the timeout value is set to “0”. In contrast, the storage devices 130a to 130c may notify non-support of the timeout process by designating the minimum timeout value to “0”, or may disregard the timeout value with respect to a specific request, command or operation.

Further, if a command to process within a timeout is refused, the storage system controller 113 may turn off the timeout function of the storage device 130a or transmit the command again to the same storage device by increasing the timeout value.

FIG. 4 is a diagram explaining an example of an API between a storage system controller and a storage device, according to an exemplary embodiment.

In Case 1, separately from an existing read API for a data A read command, an API for transmitting or setting a timeout value in a storage device and an API for acquiring a timeout value preset in the storage device are newly defined. In this case, the storage system controller 113 transmits a read command through the existing read API and transmits a timeout value through a newly defined API.

In Case 2, the existing read API for the data A read command is modified to transmit a timeout value with respect to the data A read command. In this case, the storage system controller 113 transmits the timeout value through the modified read API.

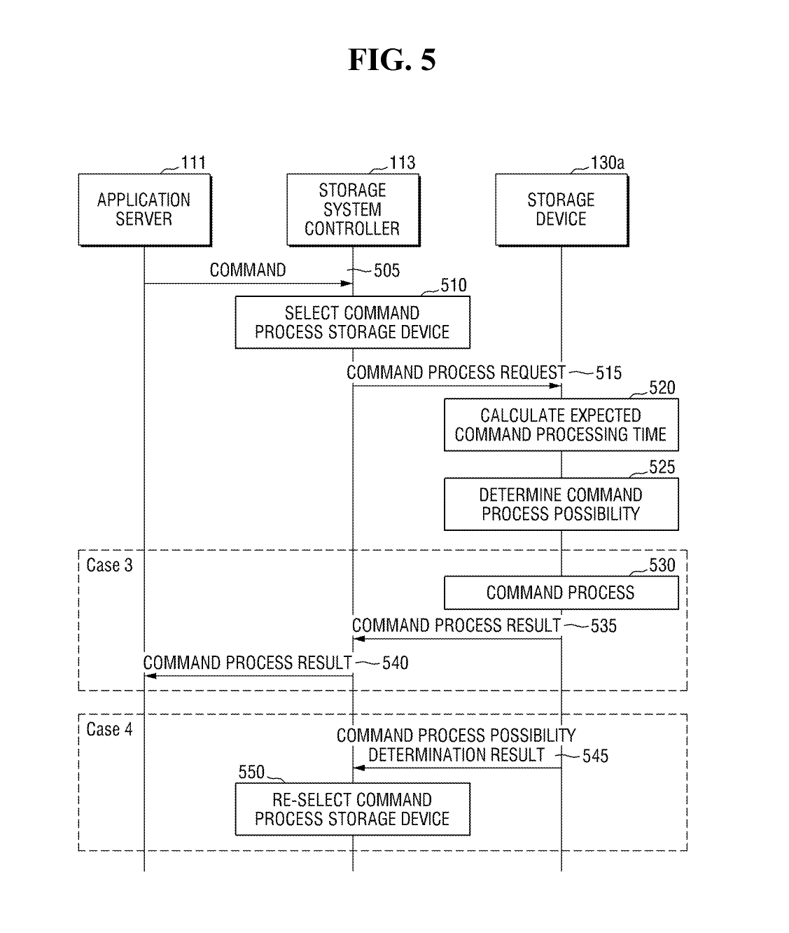

FIG. 5 is a flowchart illustrating a method for operating a storage system, according to an exemplary embodiment.

Referring to FIG. 5, according to the method for operating a storage system, an application server 111 first transmits a command to a storage system controller 113 (505). The storage system controller 113 receives the command from the application server 111 and selects a storage device 130a to process the received command among a plurality of storage devices 130a to 130c (510). In this case, various command distribution algorithms may be used.

The storage system controller 113 requests the determined storage device 130a to process the command within a timeout (515). In this case, the storage system controller 113 may transmit a value of the timeout, i.e., a timeout value, together with a command process request, and if the timeout is preset in the storage device 130a, the storage system controller 113 may not transmit the timeout value.

The timeout value that the storage system controller 113 transmits to the storage device 130a may be a value that is determined by the application server 111 or may be a value that the storage system controller 113 directly calculates based on QoS information about the application server 111. Further, the timeout value may be a value that is calculated in consideration of a delay time of the storage system controller 113.

The storage device 130a receives the command process request from the storage system controller 113 and calculates an expected processing time for processing the command by determining internal circumstances of the storage device 130a itself (520). For example, the storage device 130a may calculate the expected processing time based on the kind and the number of commands queued inside the storage device 130a, and if the storage device 130a is currently performing another command or operation (e.g., garbage collection in SSD), the storage device 130a may predict the processing time for processing the other command and operation and calculate the expected processing time for processing the command from the application server 111 based on this prediction. Further, if an error has occurred or occurs inside the storage device 130a and the recovery thereof is required, the storage device 130a may predict the recovery time, and calculate the expected processing time based on this prediction of the recovery time.

The storage device 130a determines whether the storage device 130 can process the command within the timeout by comparing the expected processing time with the timeout value transmitted from the storage system controller 113 (525). For example, if the timeout value is included in the command process request, the storage device 130a compares the timeout value with the expected processing time, and if the timeout is preset in the storage device 130a, the storage device 130a compares a value of the preset timeout with the expected processing time.

As a result of the determination (525), in the case (Case 3) where it is determined that the command can be processed within the timeout, the storage device 130a processes the corresponding command (530), and transmits a result of the command processing to the storage system controller 113 (535). The storage system controller 113, which has received the result of the command processing, transmits the result of the command processing to the application server 111 (540).

As the result of the determination (525), in the case (Case 4) where it is determined that the command cannot be processed within the timeout, the storage device 130a transmits the result of the determination that the command is unable to be processed within the timeout to the storage system controller 113 (545). In this case, the storage device 130a may transmit the result of the determination together with the calculated expected processing time (520).

Thereafter, the storage system controller 113 receives the result of the command process possibility determination and selects a storage device again, i.e., re-selects a storage device among the plurality of storage devices 130a to 130c, to process the command based on this (550).

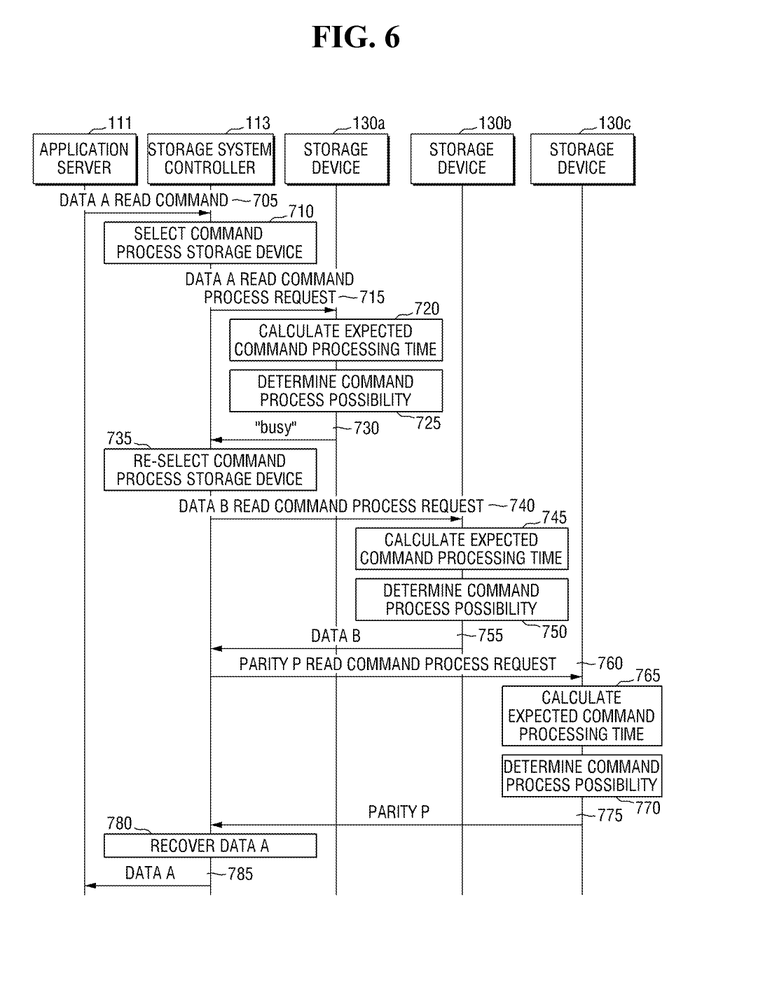

FIG. 6 is a flowchart illustrating a method for operating a storage system according to another exemplary embodiment. FIG. 6 shows an example of a storage system having replica. Case 5 is a case where it is determined that the command is unable to be processed within the timeout, and Case 6 is a case where it is determined that the command can be processed within the timeout, but the command is not actually processed within the timeout.

Here, since operations 605, 610, 615, 620 and 625 respectively correspond to operations 505, 510, 515, 520 and 525 in FIG. 5, the detailed description thereof will be omitted.

As a result of determination (625), in the case (Case 5) where the storage device 130a determines that it is unable to process a data A read command within a timeout, the storage device 130a transmits the result of the determination, such as “busy”, to the storage system controller 113 (630). The storage system controller 113, which has received this result, selects the storage device 130b to process the data A read command (635), and requests the storage device 130b to process the data A read command within the timeout (640). For example, the storage system controller 113 may select the storage device 130b, in which replica of data A is stored, as the storage device to process the data A read command.

The storage device 130b, which has received the data A read command process request, calculates an expected processing time for processing the received data A read command by determining internal circumstances of the storage device 130a itself (645). The storage device 130b determines whether it can process the data A read command within the timeout by comparing the timeout value with the expected processing time (650). For example, if the timeout value is included in the data A read command process request, the storage device 130b compares the timeout value with the expected processing time, and if the timeout is preset in the storage device 130b, the storage device 130a compares the preset timeout value with the expected processing time.

As a result of the determination (650), if the storage device 130b determines that it can process the data A read command within the timeout, the storage device 130b processes the data A read command, and transmits data A, which is a result of the processing, to the storage system controller 113 (655). The storage system controller 113 receives the data A from the storage device 130b and transmits the received data A to the application server 111 (660).

As the result of the determination (625), if the storage device 130a had determined that it could process the data A read command within the timeout, but failed to process the data A read command within the timeout (Case 6), the storage device 130a transmits a process failure message to the storage system controller 113 (665). For example, if the data A read command has not been processed within the timeout due to incorrect prediction of the expected processing time in spite of a normal state, the storage device 130a may transmit a result value that indicates a normal delay, such as “read delayed”, to the storage system controller 113. If, however, the data A read command has not been processed due to an error or trouble, the storage device 130a may transmit an error code, such as “fault”, to the storage system controller 113.

The storage system controller 113, which has received the process failure message, selects the storage device 130b to process the data A read command (670). Then, the steps 675, 680, 685, 690, and 695 are performed. Since the steps 675, 680, 685, 690, and 695 are the same as the above-described steps 640, 645, 650, 655, and 660, the detailed description thereof will be omitted.

According to an exemplary embodiment, the storage system controller 113, which has received the process failure message, may make a request again to the storage device 130a by adjusting the timeout value. Further, if the command has not been processed due to the error or trouble, the storage device 130a may operate in a recovery mode to recover the data A. Further, if the delay is caused by the data recovery, the storage device 130a may notify the storage system controller 113 that the storage device 130a is currently in a recovery mode by transmitting a predetermined message to the storage system controller 113. Further, if the error code, such as “fault”, is received from the storage device 130a or there is no response from the storage device 130a within the timeout due to a trouble of the storage device 130a, the storage system controller 113 may start recovery with respect to the storage device 130a.

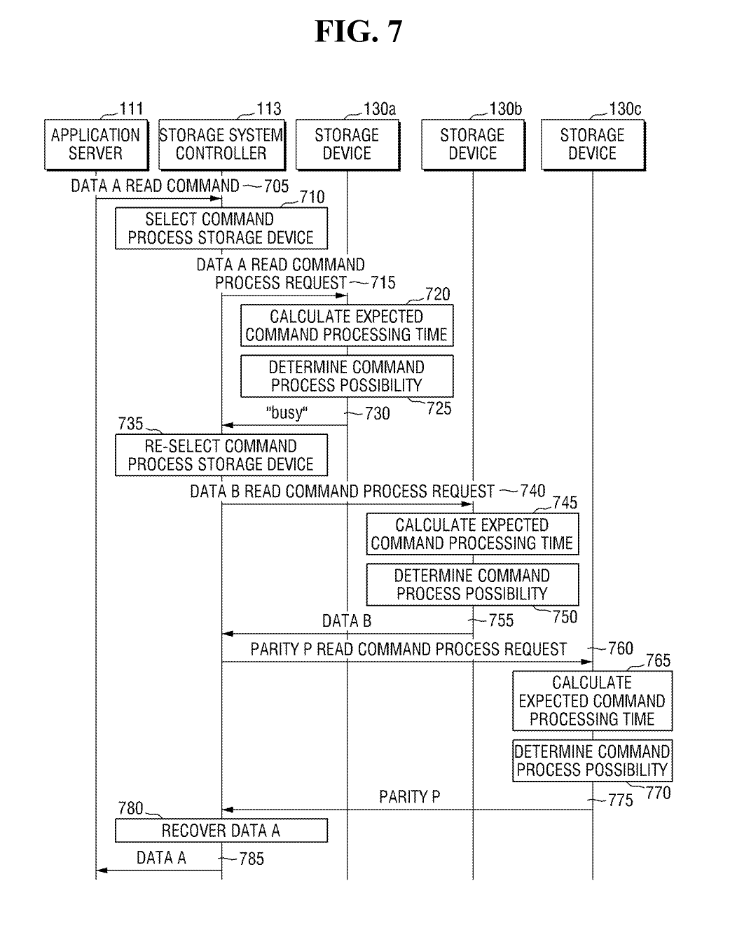

FIG. 7 is a flowchart illustrating a method for operating a storage system according to still another exemplary embodiment. FIG. 7 shows an example of a parity based storage system.

Here, since operations 705, 710, 715, 720, and 725 respectively correspond to operations 505, 510, 515, 520, and 525 in FIG. 5, the detailed description thereof will be omitted.

As a result of determination (725), in the case where the storage device 130a determines that it is unable to process a data A read command within a first timeout, the storage device 130a transmits a result of the determination, such as “busy”, to the storage system controller 113 (730). The storage system controller 113, which has received this result, selects the storage device 130b to perform a data B read command and the storage device 130c to perform a parity P read command in order to recover the data A using the data B and the parity P (735).

The storage system controller 113 requests the storage device 130b to process a data B read command within a second timeout (740), and the storage device 130b, which has received this command, calculates an expected processing time for processing the data B read command by determining internal circumstances of the storage device 130a itself (745). The storage device 130b determines whether it can process the data B read command within the second timeout by comparing the predetermined timeout value or a value of the second timeout that is received together with a data B read command process request with the expected processing time (750).

As a result of the determination (750), if the storage device 130b determines that it can process the data B read command within the second timeout, the storage device 130b processes the data B read command, and transmits the data B, which is a result of the processing, to the storage system controller 113 (755).

The storage system controller 113 requests the storage device 130c to process a parity P read command within a third timeout (760), and the storage device 130c, which has received this request, calculates an expected processing time for processing the parity P read command by determining internal circumstances of the storage device 130c itself (765). Thereafter, the storage device 130c determines whether it can process the parity P read command within the third timeout by comparing a predetermined timeout value or a value of the third timeout that is received together with a parity P read command process request with the expected processing time (770).

As a result of the determination (770), if the storage device 130c determines that it can process the parity P read command within the third timeout, the storage device 130c processes the parity P read command, and transmits the parity P, which is a result of the processing, to the storage system controller 113 (775).

The storage system controller 113, which has received the parity P, recovers the data A using the data B that is received from the storage device 130b and the parity P that is received from the storage device 130c (780), and transmits the recovered data A to the application server 111 (785). Here, the first to third timeouts for processing the data A read command, the data B read command and the parity P read command, respectively, may be the same or different from one another.

It is not always necessary to perform the operation (740) in which the storage system controller 113 request the storage device 130b to process the data B read command, the operations (745, 750, and 755) in which the storage device 130b receives this request and operates accordingly, the operation (760) in which the storage system controller 113 requests the storage device 130c to process the parity P read command, and the operations (765, 770, and 775) in which the storage device 130c receives this request and operates accordingly, in the order as illustrated above. That is, the above-described operations may be performed simultaneously or in the reverse order.

It is also possible that the storage device 130a transmits the calculated expected processing time (720) together with the result of the determination, such as “busy”, to the storage system controller 113. In this case, if the expected processing time is slightly different from the timeout value that is calculated by the storage system controller 113 and the difference is susceptible, the storage system controller 113 may request the storage device 130a again by increasing the timeout value. Further, if the error code, which is not a normal delay, such as “busy”, is received from the storage device 130a or no response is received even after elapse of the timeout, the storage system controller 113 may process the request of the application server 111 through recovery of corresponding data from other storage devices 130b and 130c, and then may recover the corresponding storage device 130a.

Various units represented by a block as illustrated in FIGS. 2 and 3 may be embodied as the various numbers of hardware, software and/or firmware structures that execute respective functions described above, according to exemplary embodiments. For example, these units may use a direct circuit structure, such as a memory, processing, logic, a look-up table, etc. that may execute the respective functions through controls of one or more microprocessors or other control apparatuses. These units may be specifically embodied by a module, a program, or a part of code, which contains one or more executable instructions for performing specified logic functions. Also, at least one of these units may further include a processor such as a central processing unit (CPU) that performs a respective function, a microprocessor, or the like.

While the inventive concept has been particularly shown and described with reference to the above exemplary embodiments, it will be understood by those of ordinary skill in the art that various changes in form and details may be made therein without departing from the spirit and scope of the inventive concept as defined by the following claims. It is therefore desired that the present embodiments be considered in all respects as illustrative and not restrictive, reference being made to the appended claims rather than the foregoing description to indicate the scope of the invention.

What is claimed is:

1. A controller of a storage system including a plurality of storage devices, comprising:
a storage device selection unit configured to select a storage device to process a command among the plurality of storage devices;
a command process request unit configured to request the selected storage device to process the command within a timeout,
wherein the storage device selection unit configured to re-select a storage device among the plurality of storage devices to process the command according to a result of determining whether the command can be processed by the selected storage device within the timeout.

2. The controller of a storage system of claim 1, wherein the command process request unit transmits information about the timeout to the selected storage device when requesting the selected storage device to process the command within the timeout.

3. The controller of a storage system of claim 1, further comprising a timeout value calculation unit configured to calculate a value of the timeout differently according to a characteristic of at least one of the command, an application server generating the command, and the storage devices.

4. The controller of a storage system of claim 1, further comprising a timeout value calculation unit configured to calculate a value of the timeout based on Quality of Service information about an application server that generates the command.

5. The controller of a storage system of claim 1, further comprising a command queuing unit configured to receive and queue the command from an application server.

6. The controller of a storage system of claim 1, further comprising a timeout setting request unit configured to request the storage device to set the timeout in the storage device.

7. The controller of a storage system of claim 1, further comprising a timeout information request unit configured to request the storage device, in which the timeout is preset, to provide information about the preset timeout.

8. A storage device of a storage system, comprising:
an expected processing time calculation unit configured to calculate an expected processing time for processing a command in accordance with a command process request from a storage system controller; and
a command process possibility determination unit configured to determine whether the command can be processed within a timeout based on the calculated expected processing time.

9. The storage device of claim 8, further comprising a determination result transmission unit configured to transmit a result of the determination to the storage system controller.

10. The storage device of claim 9, wherein the determination result transmission unit is further configured to transmit the calculated expected processing time together with the result of the determination if it is determined that the command is unable to be processed within the timeout.

11. The storage device of claim 8, further comprising a timeout setting unit configured to set the timeout in accordance with a timeout setting request of the storage system controller.

12. The storage device of claim 8, further comprising a timeout information providing unit configured to provide information about the timeout to the storage system controller in accordance with a timeout information request from the storage system controller.

13. The storage device of claim 8, further comprising a command processing unit configured to process the command and transmit a result of the processing the command to the storage system controller if it is determined that the command can be processed within the timeout.

14. A storage system comprising:
two or more of the storage device of claim 7; and
a storage system controller configured to select a storage device to process the command among the two or more of the storage device, and request the selected storage device to process the command within the timeout,
wherein the storage system controller is further configured to re-select a storage device among the two or more of the storage device to process the command according to a result of determining whether the command can be processed by the selected storage device within the timeout.

15. The storage system of claim 13, wherein the storage system controller further comprises a timeout value calculation unit configured to calculate a value of the timeout differently according to a characteristic of at least one of the command, an application server generating the command, and the two or more of the storage device.

16. A method of controlling a storage system including a plurality of storage devices, the method comprising:
first-selecting a storage device to process a first command within a first processing time, from among the plurality of storage devices;
determining wherein the first-selected storage device is capable of processing the first command within the first processing time; and
second-selecting a storage device to process a second command within a second processing time, from among the plurality of storage devices, according to a result of the determining.

17. The method of claim 15, wherein the first command is the same as the second command,
wherein the first processing time is the same as the second processing time, and
wherein the second-selected storage device is different from the first-selected storage device.

18. The method of claim 15, wherein the first command is the same as the second command,
wherein the first processing time is different from the second processing time, and
wherein the second-selected storage device is the same as the first-selected storage device.

19. The method of claim 16, the method further comprising:
third-selecting a storage device to process a third command within a third processing time, from among the plurality of storage devices, according to the result of the determining, wherein the third-selected storage device is different from either of the first-selected storage device and the second-selected storage device, and the third command is different from either of the first command and the second command; and
obtaining a result of processing the first command by controlling the second-selected storage device to process the second command within the second processing time and controlling the third-selected storage device to perform the third command within the third processing time.

20. The method of claim 19, wherein the first command is a command to read first data stored in the first-selected storage device,
wherein the second command is a command to read second data stored in the second-selected storage device,
wherein the third command is a command to read a parity stored in the third-selected storage device, and
wherein the result of the processing the first command is obtained based on the second data and the parity read by the second and third commands, respectively.
